(19) United States
(12) Patent Application Publication
(10) Pub. No.: US 2008/0072068 A1
(43) Pub. Date: Mar. 20, 2008

(54) METHODS AND APPARATUSES FOR SECURING FIRMWARE IMAGE DOWNLOAD AND STORAGE BY DISTRIBUTION PROTECTION

(76) Inventors: Liang-Yun Wang, Taipei City (TW); Kuo-Chang Li, Hsinchu City (TW); Tau-Li Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/532,915

(22) Filed: Sep. 19, 2006

(51) Int. Cl. G06F 12/14

(52) U.S. Cl. 713/191

(57) ABSTRACT

A method for obtaining a firmware image from a second encrypted data having an encrypted firmware image. The encrypted firmware image is generated from the firmware image sequentially encrypted utilizing a first encryption key and a second encryption key. The first encryption key is specified for securing the firmware image. The second encryption key is specified for securing a distribution of the firmware image. The method includes: providing a second decryption key specified for decrypting the second encrypted data; decrypting at least the encrypted firmware image utilizing the second decryption key to generate a first encrypted data; providing a first decryption key specified for decrypting the first encrypted data; and decrypting the first encrypted data utilizing the first decryption key to obtain the firmware image.

### BACKGROUND

The invention relates to firmware download and storage, and more particularly, to methods and apparatuses for securing firmware image download and storage by a distribution protection.

Our world is now controlled by countless embedded systems from microwave ovens and traffic lights, to ATMs. Many of them guard our personal safety, while some guard our financial security.

In addition to a reliable hardware platform of an embedded system, a firmware plays an important role in making the embedded system operate correctly. In general, the firmware acts as an interface between a host and the embedded system, such as a peripheral device connected to the host. After receiving commands from the host, the peripheral device executes its firmware to control internal components according to the received commands. However, it is possible that the firmware has bugs or requires a new functionality. Therefore, a firmware updating mechanism is developed to overwrite currently used firmware in order to fix bugs or add new functionality to the peripheral device. For devices that can update their own firmware, especially through the use of the Internet, the integrity of the firmware update becomes an important issue.

Another issue regarding firmware running on an embedded system is that the firmware might carry confidential information that must be hidden from competitors and/or hackers. As mentioned above, the firmware is responsible for controlling the circuit components according to the received commands from the host. Taking an optical disc drive for example, the firmware is executed to set parameters associated with data reading and recording. Therefore, setting the parameters to achieve optimum performance is carried out by the firmware designer. However, firmware image can easily be read out from a flash ROM chip without too much professional knowledge. Moreover, the firmware image required by the firmware update can usually be downloaded from the manufacturer's website, which is open to anybody.

The conventional schemes for protecting firmware from being stolen or modified are either too expensive to be implemented on a low-cost platform, or too weak to provide effective protection. For example, a common way to protect firmware from being stolen is to perform some bit operations on the firmware image to scramble it before distribution. After the scrambled firmware image is received, the processor must unscramble it before execution. The bit operation is usually fixed for every memory address, and no secret key is applied. This kind of protection is very weak because the scrambling algorithm can be easily understood, particularly for 8-bit machines where the scrambling boundary is almost limited to single bytes.

A hash algorithm can be utilized for integrity verification. For example, the processor verifies the integrity of the firmware by creating the hash of the whole firmware and then compares it with a digital signature that comes with the firmware. Hashing the whole firmware image on every booting is not practical for devices without much computing power, however.

For algorithms that do utilize secret keys, the secret keys are stored in the hardware (e.g. integrated into the system-on-chip, or an external memory device like FLASH ROM). For instance, the manufacturer of a specific device utilizes a secret key specified for protecting contents of the designed firmware. Then, the encrypted firmware can be freely downloaded by anyone. However, only the specific device has the secret key to decrypt the downloaded data and obtain the correct firmware image. In general, the firmware image is encrypted according to a simple encryption algorithm such that the specific device can quickly decrypt the protected firmware without degrading the performance. In other words, the firmware decrypted by utilizing secret keys still has weak protection due to the simple encryption algorithm.

An IC vendor might sell their ICs, having the functionality of decrypting the received firmware image, to various end-product manufacturers. The secret key defined by the IC vendor is shared between various end-product manufacturers for encrypting firmware designed for products of different manufacturers. If one manufacturer leaks the secret key, all manufactures are affected. Utilizing Public Key Infrastructure or other complex key management systems can reduce this risk, but is usually too expensive to be implemented in simple hardware with poor decrypting power.

Some encrypting systems let every single device has its own unique secret key, but it is considerably more expensive to create a microprocessor or SoC chip with embedded e-fuse technology. Let every set maker has its own secret key, and the responsibility to keep it safe, might be more balanced between cost and security, from the IC vendor's point of view.

Some systems encrypt the firmware so it can pass through internet safely, but decrypt it on the host computer before passing down to the device. This stage can be the biggest hole in firmware updates. Computer viruses, especially in PC world, can intercept and modify firmware updates without much effort.

### SUMMARY

It is therefore one of the objectives of the claimed invention to provide methods and apparatuses for securing firmware image download and storage by a distribution protection, to solve the above problems. According to an embodiment of the claimed invention, a method for securing a distribution of a firmware image is disclosed. The method comprises: providing an encryption key specified for securing the distribution of the firmware image; providing an authentication code used for validating distribution of the firmware image; and encrypting at least the firmware image utilizing the encryption key.

According to an embodiment of the claimed invention, a method for encrypting a firmware image to be distributed is disclosed. The method comprises providing an encryption key specified for securing the distribution of the firmware image; providing an authentication code used for validating the distribution of firmware image; and encrypting at least the firmware image utilizing the encryption key.

According to an aspect of the claimed invention, a method for obtaining a firmware image from an encrypted data having an encrypted firmware image is disclosed. The encrypted firmware image is generated according to an encryption key specified for securing a distribution of the firmware image, the method comprises providing a decryption key specified for decrypting the encrypted data, wherein the encrypted data further comprises an authentication code for validating the distribution of firmware image; decrypting the encrypted firmware image utilizing the decryption key to obtain the firmware image.

According to an aspect of the claimed invention, an encryption apparatus for securing a distribution of a firmware image is disclosed. The encryption apparatus comprises an encryption key provider capable of generating an encryption key specified for securing the distribution of the firmware image; an encryption unit, coupled to the encryption key provider, for encrypting the firmware image utilizing the encryption key; and an authentication code provider, coupled to the encryption unit, for providing an authentication code used for validating distribution of the firmware image.

According to an embodiment of the claimed invention, a decryption apparatus for obtaining a firmware image from an encrypted data having an encrypted firmware image is disclosed. The encrypted firmware image is generated according to an encryption key specified for securing a distribution of the firmware image, the decryption apparatus comprises a decryption key provider capable of providing a decryption key specified for decrypting the encrypted data, wherein the encrypted data comprises an authentication code for validating the distribution of the firmware image; and a decryption unit, coupled to the decryption key provider, for decrypting the encrypted firmware image utilizing the decryption key to obtain the firmware image.

It is an advantage of the claimed invention that the present invention can utilize a fixed pattern to act as the authentication code. Therefore, no complicated computation is required to calculate the authentication code. The integrity verification scheme of the present invention is applicable to devices without much computing power. In addition, the present invention adopts multiple protections for securing the firmware image from being leaked out. That is, in addition to a layer 1 encryption given by a simple encryption algorithm, the present invention includes a layer 2 encryption corresponding to a complex encryption algorithm to give a robust protection to distribution of the firmware image. Furthermore, the target decryption keys set to products could be programmable by corresponding manufacturers, as products of different manufacturers do not share the same secret key set anymore. The related art secret key leakage problem is solved accordingly.

### BRIEF DECRYPTION OF THE DRAWINGS

FIG. 1 is a block diagram of a firmware security system according to an embodiment of the present invention.

FIG. 2 is a flowchart of a method employed by the firmware security system for securing the firmware distribution according to a first embodiment of the present invention.

FIG. 3 is a diagram illustrating the first embodiment of the present invention.

FIG. 4 is a flowchart of a method employed by the firmware security system for securing the firmware distribution according to a second embodiment of the present invention.

FIG. 5 is a diagram illustrating the second embodiment of the present invention.

FIG. 6 is a flowchart of a method employed by the firmware security system for securing the firmware distribution according to a third embodiment of the present invention.

FIG. 7 is a diagram illustrating the third embodiment of the present invention.

FIG. 8 is a flowchart of a method employed by the firmware security system for securing the firmware distribution according to a fourth embodiment of the present invention.

FIG. 9 is a diagram illustrating the fourth embodiment of the present invention.

### DETAILED DECRYPTION

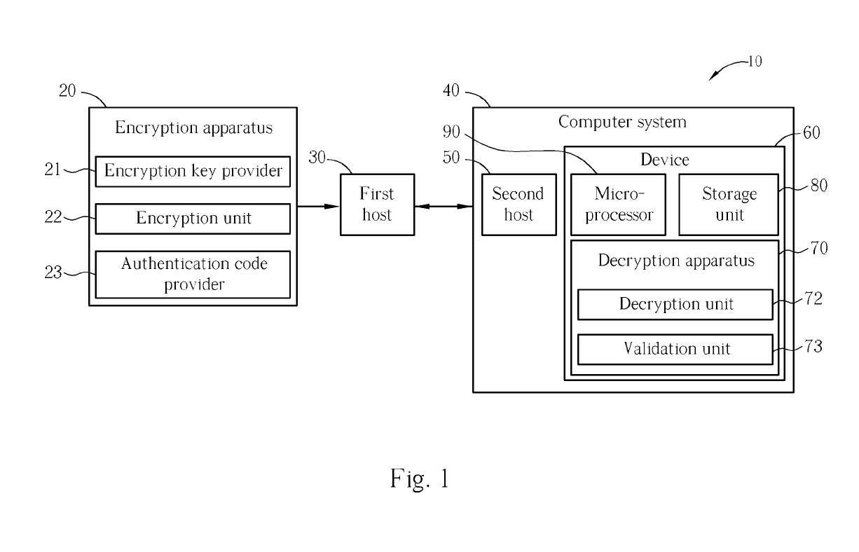

Please refer to FIG. 1. FIG. 1 is a block diagram of a firmware security system 10 according to an embodiment of the present invention. The firmware security system 10 includes an encryption apparatus 20, a first host 30 and a computer system 40. As shown in FIG. 1, the encryption apparatus 20 includes an encryption key provider 21, an encryption unit 22 and an authentication code provider 23. Please note that the encryption key provider 21 is capable of providing an encryption key specified for securing the firmware image or an encryption key for securing the distribution of the firmware image, where the encryption key for securing the firmware image is for a simple encryption algorithm, such as a Data Encryption Standard (DES). The encryption key specified for securing the distribution of the firmware image is for a complex encryption algorithm, such as an Advanced Encryption Standard (AES). The encryption unit 22 is coupled to the encryption key provider 21 for encrypting at least the firmware image utilizing a corresponding encryption key according to the encryption mode, DES or AES. The authentication code provider 23 is coupled to the encryption unit 22 and provides an authentication code used for validating decryption of the encrypted firmware image. In this embodiment, the authentication code provider 23 generates the authentication code according to a digest algorithm or a hash algorithm. However, the present invention is not limited to above-mentioned authentication code generating algorithms. Any available algorithm capable of generating a desired authentication code, like all various kinds of HMAC for hash-function-based or CMAC for cipher-based Message Authentication Code algorithms, can be implemented by the present invention.

Please note that for different products the encryption apparatus 20 makes use of different secret key sets and authentication codes to encrypt firmware applicable to these different products. For example, products of different manufacturers do not share the same secret key set, i.e. each product has a unique secret key set. As shown in FIG. 1, the first host 30 is coupled to the encryption apparatus 20, and stores a plurality of predetermined encrypted data each having a specific encrypted firmware image generated from a firmware image encrypted utilizing a specific encryption key specified for securing a distribution of the firmware image.

In this embodiment, the computer system 40 is coupled to the first host 30 via the Internet, and is capable of downloading a target encrypted data from the first host 30 via the Internet. Please note that the present invention is not limited to an Internet connection linking the first host 30 and the computer system 40. The computer system 40 includes a second host 50 and a device 60 (e.g. an optical disc drive). After establishing connection to the first host 30, the second host 50 selects a specific encrypted data associated with a target secret key set to be the target encrypted data needed by the connected device 60, and then downloads the target encrypted data from the first host 30 via the Internet. As shown in FIG. 1, the device 60 includes a decryption apparatus 70, storage unit 80 and microprocessor 90. As mentioned above, each product has a unique secret key set according to the present invention. In this embodiment, the storage unit 80 stores a plurality of secret key sets each having at least a decryption key, and the microprocessor 90, during boot-up process, can select one of the stored secret key sets to be the target decryption key set of the device 60 according to hardware configuration. The hardware configuration here is defined by settings of a plurality of input pins which can be changed via exterior circuit design, or fused or laser-cut which directly adjust the integrated circuit, or NVRAM like embedded FLASH ROM. In other words, the microprocessor 90 checks statuses of the registers to make the secret key selection. The combination of the microprocessor 90 and the storage unit 80 acts as a decryption key provider for providing a decryption key set of the device 60 through selecting one key set from candidate key sets.

The decryption apparatus 70 utilizes the selected decryption key set for decrypting data (encrypted firmware image) encrypted by the encryption apparatus 20 utilizing a target encryption key set. The decryption apparatus 70 includes a decryption unit 72 and a validation unit 73. The decryption unit 72 utilizes the selected decryption key set to decrypt data downloaded from the first host 30 according to the Advanced Encryption Standard (AES) or Data Encryption Standard (DES) in a Cipher Block Chaining (CBC) mode to obtain the firmware image. The validation unit 73 then checks an authentication code included in the encrypted data to validate decryption of the encrypted firmware image. The encryption and decryption operations performed by the firmware security system 10 are detailed as follows.

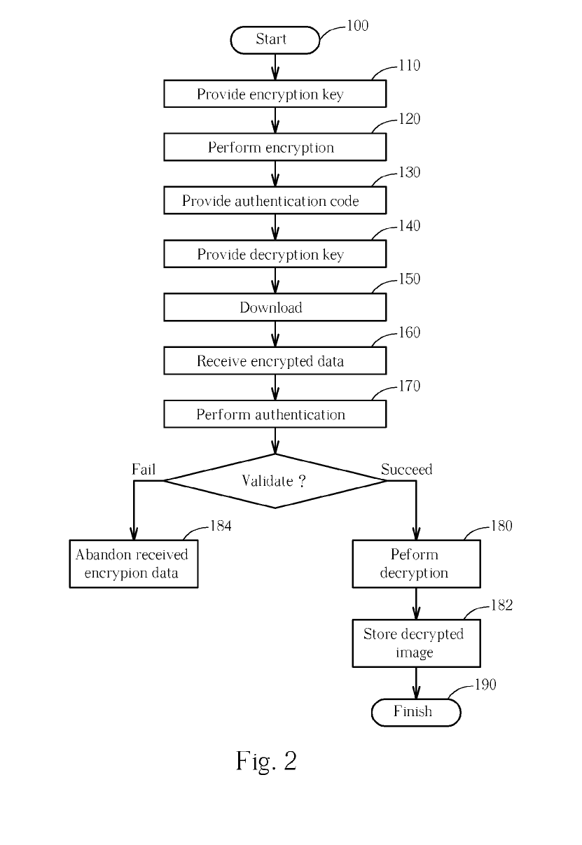

Please refer to FIG. 2. FIG. 2 is a flowchart of a method employed by the firmware security system 10 for securing the firmware distribution according to a first embodiment of the present invention. The method of securing the firmware distribution includes the following steps:

Step 100: Start.

Step 110: Provide Encryption Key. The encryption key provider 21 is capable of generating an encryption key K2 specified for securing the distribution of the firmware image for the device 60.

Step 120: Perform Encryption. The encryption unit 22 receives the encryption key K2 from the encryption key provider 21, and then encrypts the raw firmware image utilizing the encryption key K2. In this embodiment, the encryption unit 22 encrypts the raw firmware image for providing a stronger protection according to an Advanced Encryption Standard (AES) encryption in a Cipher Block Chaining (CBC) mode.

Step 130: Provide Authentication Code. The authentication code provider 23 provides an authentication code CA used for validating the encrypted data and adds the authentication code to the encrypted data. In this embodiment, the authentication code provider 23 inserts a fixed pattern, such as “MediaTek”, into some known location of the before-encrypted data as the authentication code CA or performs a predetermined algorithm, such as a digest algorithm or a hash algorithm, to determine the authentication code CA.

Step 140: Provide Decryption Key. The decryption key provider, implemented by the microprocessor 90 and the storage unit 80, is capable of providing a decryption key K2 specified for decrypting the encrypted data. In this embodiment, the decryption key and the encryption key are the same. However, for other embodiments of the present invention utilizing other encryption/decryption algorithms, the decryption key is allowed to be different from the encryption key.

Step 150: Download. The second host 50 downloads a target encrypted data from a first host 30 via the Internet, where the target encrypted data is encrypted according to the encryption key K2.

Step 160: Receive Encrypted Data. The device 60 of the computer system 40 receives encrypted data from the second host 50 through IDE or other interface, like SATA, and stores the received encrypted data in a volatile memory (e.g., DRAM) for following decryption and authentication operations.

Step 170: Perform Authentication. The validation unit 73 utilizes an authentication code transmitted by the encrypted data to validate the encrypted firmware image. If the validation is passed, go to step 180; otherwise, go to step 184.

Step 180: Perform Decryption. The decryption unit 72 decrypts the encrypted firmware image in the encrypted data utilizing the decryption key K2 to obtain the firmware image. In this embodiment, the decryption can also be performed in parallel with receiving the encrypted data from the second host 50 (step 160).

Step 182: Store Decrypted Firmware Image. The decryption unit 72 stores the firmware image into a non-volatile memory (e.g. flash memory) or the microprocessor 90 directly loads and executes the firmware image from the volatile memory. Then go to step 190.

Step 184: Abandon Received Encrypted data. The decryption unit 72 abandons the received encrypted data and informs the second host 50 of the validation failure.

Step 190: Finish.

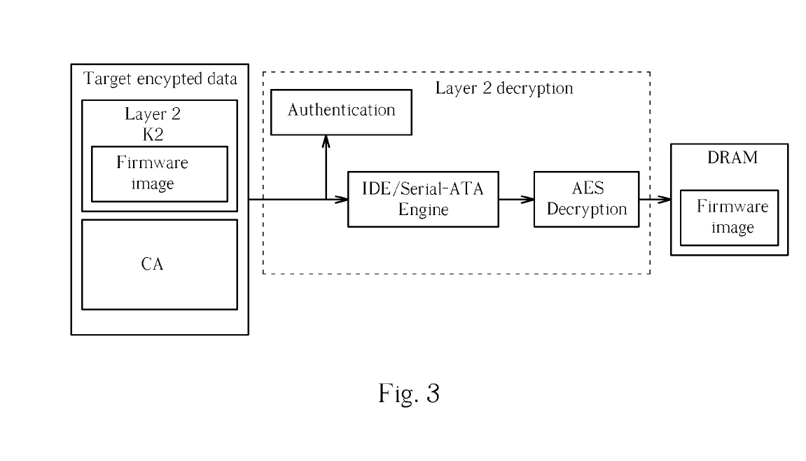

Please refer to FIGS. 1 and 3. FIG. 3 is a diagram illustrating the first embodiment of the present invention. The firmware image is protected by an encryption associated with the encryption key K2. Then, the authentication code CA is attached to the encrypted firmware image. The target encrypted data is distributed and downloaded. The validation unit 73 verifies the target decrypted data does contain the pre-determined code. Any modification to the encrypted firmware image would result to trashed final output due to the nature of Chained cipher operation. If the authentication code CA transmitted by the encrypted data matches a predetermined pattern, the decryption unit 72 decrypts the encrypted firmware image using K2 during downloading through IDE/SATA to obtain the desired firmware image. Then, the firmware image is stored and executed in DRAM. Please note that the device 60 is not limited to starting the authentication of the encrypted data after the whole encrypted data containing the authentication information and encrypted firmware image are received. Segments of the encrypted data can be downloaded and authenticated separately, as long as the relationship between segments is kept unmodified. It is also possible to interrupt the download sequence as long as the authentication status is able to be maintained across the download sequence.

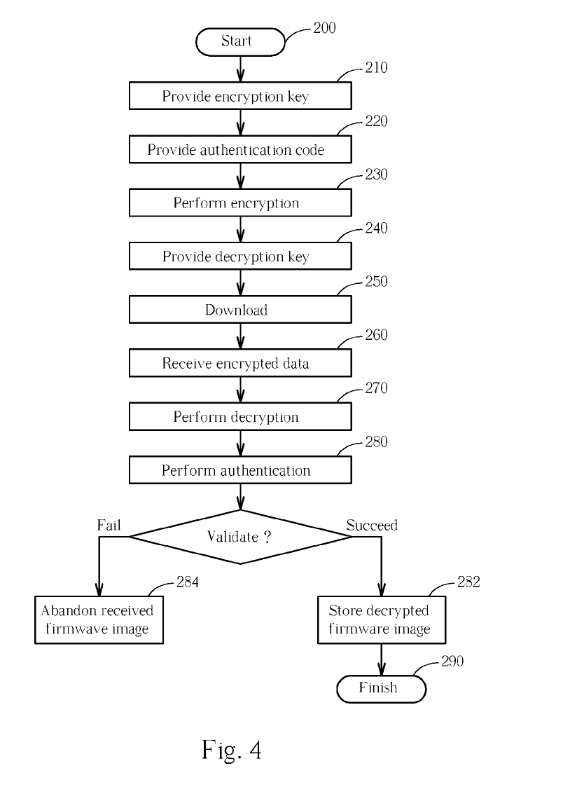

Please refer to FIG. 4. FIG. 4 is a flowchart of a method employed by the firmware security system 10 for securing the firmware distribution according to a second embodiment of the present invention. The differences between this embodiment and the first embodiment are that: the sequence of providing authentication code and performing encryption is transposed, provide authentication code (Step 220) first, and then perform encryption (Step 230); and the step of performing decryption (Step 270) is brought forward and inserted between the step of receiving encrypted data (Step 260) and the step of performing authentication (Step 280). Then, after validation is passed, only store decrypted firmware image (Step 282) in this embodiment.

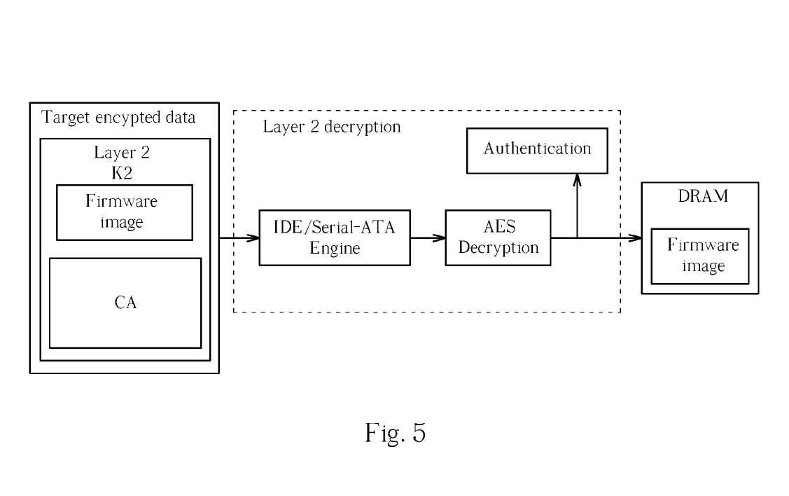

Please refer to FIGS. 1 and 5. FIG. 5 is a diagram illustrating the second embodiment of the present invention. The differences between the present embodiment and the first embodiment are that both the firmware image and the authentication code CA are protected by an encryption associated with the encryption key K2; the decryption unit 72 firstly decrypts the target encrypted data using K2 during downloading; and then the validation unit 73 verifies the decrypted data does contain the pre-determined code after the target encrypted data is received and decrypted. If the authentication code CA decrypted from the encrypted data matches a predetermined pattern, the concurrently decrypted firmware image is stored and executed in DRAM.

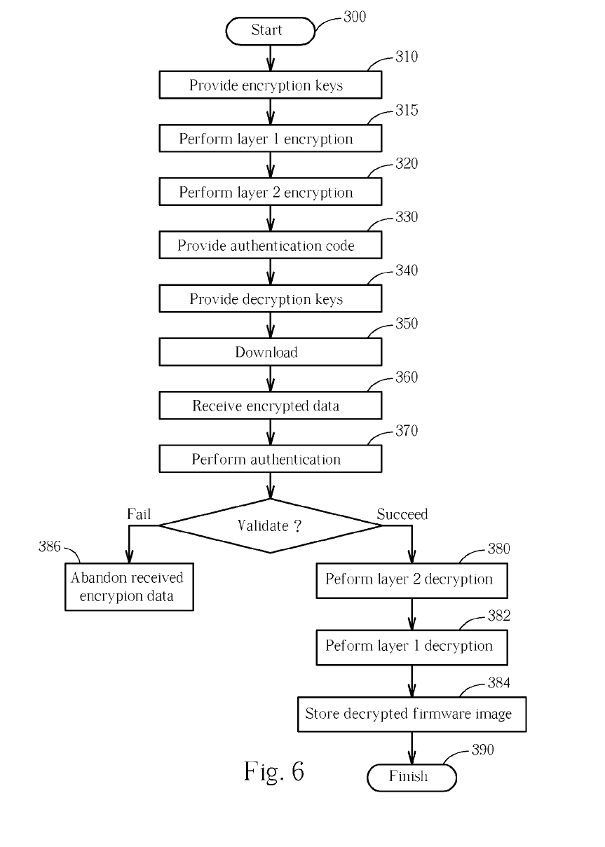

Please refer to FIG. 6. FIG. 6 is a flowchart of a method employed by the firmware security system 10 for securing the firmware distribution according to a third embodiment of the present invention. The method of securing the firmware distribution includes the following steps:

Step 300: Start.

Step 310: Provide Encryption Keys. The encryption key provider 21 is capable of generating an encryption key K1 specified for securing the firmware image for the device 60 and an encryption key K2 specified for securing the distribution of the firmware image for the device 60. Please note that K1 appears here and the following may be different from K2.

Step 315: Perform Layer 1 Encryption. The encryption unit 22 receives the encryption key K1 from the encryption key provider 21, and then encrypts the raw firmware image to generate a first encrypted data utilizing the encryption key K1. In this embodiment, the encryption unit 22 encrypts the raw firmware image for providing a simple protection according to a Data Encryption Standard (DES) encryption.

Step 320: Perform Layer 2 Encryption. The encryption unit 22 receives the encryption key K2 from the encryption key provider 21, and then encrypts the first encrypted data to generate a second encrypted data utilizing the encryption key K2. In this embodiment, the encryption unit 22 encrypts the raw firmware image for providing a stronger protection according to an Advanced Encryption Standard (AES) encryption in a Cipher Block Chaining (CBC) mode.

Step 330: Provide Authentication Code. The authentication code provider 23 provides an authentication code CA used for validating the second encrypted data and adds the authentication code to the second encrypted data. In this embodiment, the authentication code provider 23 inserts a fixed pattern, such as “MediaTek”, into some known location of the before-encryption data as the authentication code CA or performs a predetermined algorithm, such as a digest algorithm or a hash algorithm, to determine the authentication code CA.

Step 340: Provide Decryption Keys. The decryption key provider, implemented by the microprocessor 90 and the storage unit, is capable of providing a decryption key K1 specified for decrypting the first encrypted data and a decryption key K2 specified for decrypting the second encrypted data. In this embodiment, the decryption keys and the corresponding encryption keys are the same. However, for other embodiments of the present invention utilizing other encryption/decryption algorithms, the decryption keys are allowed to be different from the corresponding encryption keys.

Step 350: Download. The second host 50 downloads a target encrypted data from a first host 30 via the Internet, where the target encrypted data is encrypted according to the encryption keys K1 and K2.

Step 360: Receive Encrypted Data. The device 60 of the computer system 40 receives encrypted data from the second host 50 through IDE or other interface, like SATA, and stores the received encrypted data in a volatile memory (e.g., DRAM) for following decryption and authentication operations.

Step 370: Perform Authentication. The validation unit 73 utilizes an authentication code transmitted by the target encrypted data to validate the second encrypted data. If the validation is passed, go to step 380; otherwise, go to step 386.

Step 380: Perform Layer 2 Decryption. The decryption unit 72 decrypts the second encrypted data utilizing the decryption key K2 to obtain the first encrypted data. In this embodiment, the decryption (step 380) can also be performed in parallel with receiving the encrypted data from the second host 50 (step 360).

Step 382: Perform Layer 1 Decryption. The decryption unit 72 decrypts the first encrypted data utilizing the decryption key K1 to obtain the desired firmware image.

Step 384: Store Decrypted Firmware Image. The decryption unit 72 stores the firmware image into a non-volatile memory (e.g. flash memory) or the microprocessor 90 directly loads and executes the firmware image from the volatile memory. Go to step 190.

Step 386: Abandon Received Encrypted Data. The decryption unit 72 abandons the received encrypted data and informs the second host 50 of the validation failure.

Step 390: Finish.

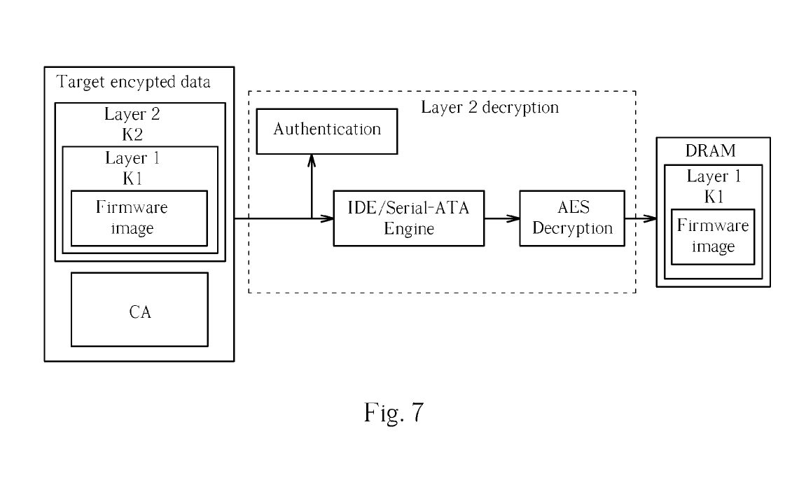

Please refer to FIG. 7. FIG. 7 is a diagram illustrating the third embodiment of the present invention. The firmware image is protected by encryptions associated with the encryption keys K1 and K2, respectively. Then, the authentication code CA is attached to the second encrypted data containing the encrypted firmware image. The target encrypted data is distributed and downloaded. After the target encrypted data is received and decrypted, the validation unit 73 verifies the decrypted data does contain the pre-determined code. Any modification to the encrypted image would result to trashed final output due to the nature of Chained cipher operation. If the authentication code CA transmitted by the encrypted data matches a predetermined pattern, the decryption unit 72 decrypt the target encrypted data using K2 during downloading through IDE/SATA to obtain the first encrypted data. Then, the first encrypted data is stored and executed in DRAM. Please note that the device 60 is not limited to starting the authentication of the second encrypted data after the whole encrypted data containing the authentication information and second encrypted data are received. Segments of the encrypted data can be downloaded and authenticated separately, as long as the relationship between segments is kept unmodified. It is also possible to interrupt the download sequence as long as the authentication status is able to be maintained across the download sequence.

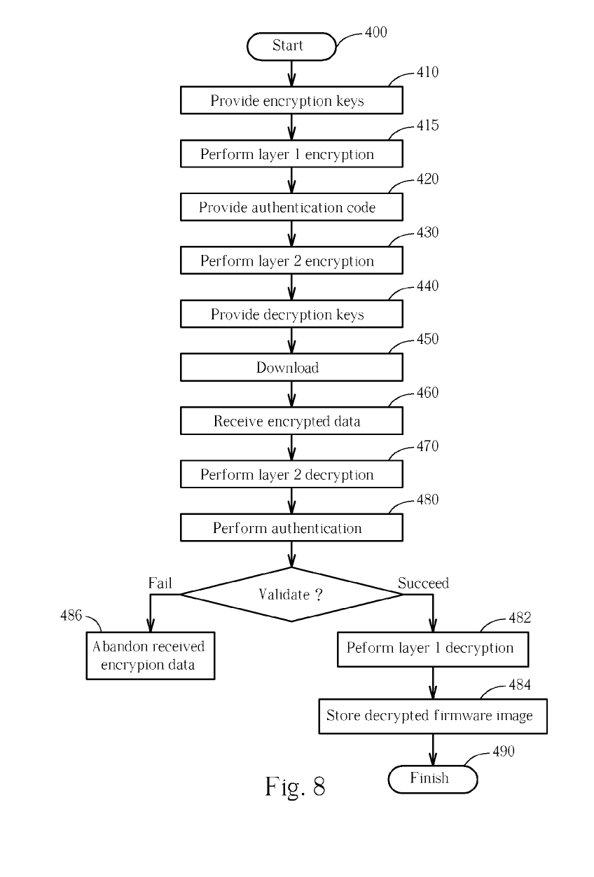

Please refer to FIG. 8. FIG. 8 is a flowchart of a method employed by the firmware security system 10 for securing the firmware distribution according to a fourth embodiment of the present invention. The differences between the fourth embodiment and the third embodiment are that: the sequence of providing authentication code and the sequence of performing layer 2 decryption are changed. In this embodiment the step of providing authentication code (Step 420) is inserted between the step of performing layer 1 encryption (Step 415) and the step of performing layer 2 encryption (Step 430). And the step of performing layer 2 decryption (Step 470) is brought forward and inserted between the step of receiving encrypted data (Step 460) and the step of performing authentication (Step 480). Then when performing authentication, only utilizing the authentication code to validate the first encrypted data rather than validate the second encrypted data in the third embodiment.

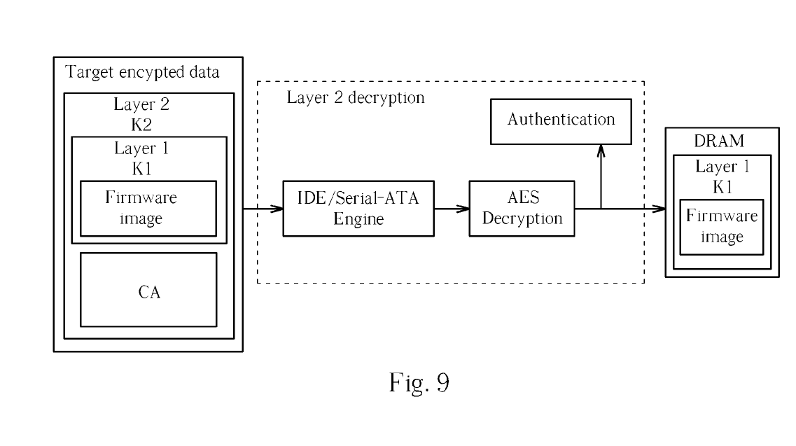

Please refer to FIG. 9. FIG. 9 is a diagram illustrating the fourth embodiment of the present invention. Referring to FIG. 7 together, the differences between this embodiment and the third embodiment are that: both the authentication code CA and the first encrypted data, which contains the firmware image protected by an encryption associated with the encryption key K1, are protected by an encryption associated with the encryption key K2 in this embodiment; and do not perform authentication until the target encrypted data is received and decrypted.

Please note that in the above embodiments, DES or AES encryption/decryption is applied. However, the above-mentioned encryption/decryption scheme is only meant to be taken as examples, and is not meant to be limitations of the present invention.

Compared with the related art, an embodiment of the present invention can utilize a fixed pattern (e.g., “MediaTek”) to act as the authentication code. Therefore, no extra computation is required to calculate the authentication code besides decryption of some small amount of data. Other cipher-based Message Authentication Code algorithms (CMACs) also hold similar property. The integrity verification scheme of the present invention is applicable to devices without much computing power. In addition, the present invention adopts multiple protections for securing the firmware image from being leaked out. That is, in addition to a layer 1 encryption given by a simple encryption algorithm, the present invention includes a layer 2 encryption corresponding to a complex encryption algorithm to give a robust protection to distribution of the firmware image. Furthermore, the aforementioned storage unit 80 shown in FIG. 1 stores a plurality of decryption key sets, and a target decryption key set for a specific product is adjustable even after the chip is manufactured. Assume that the microprocessor 90, the storage unit 80, and the decryption apparatus 70 are integrated in a single chip. The same chips can be applied to products of different manufacturers. However, because the target decryption keys set to these products could be chosen by manufacturers, products of different manufacturers do not share the same secret key set anymore. The related art secret key leakage problem is solved accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for securing a distribution of a firmware image, the method comprising:
providing an encryption key specified for securing the distribution of the firmware image;
providing an authentication code used for validating the distribution of firmware image; and
encrypting at least the firmware image utilizing the encryption key.

2. The method of claim 1, wherein the step of encrypting the firmware image utilizing the encryption key further comprises encrypting the authentication code.

3. The method of claim 1, wherein the method further comprises adding the authentication code to the encrypted firmware image.

4. The method of claim 1, wherein the firmware image is to be distributed via the Internet.

5. The method of claim 1, wherein the authentication code is a fixed pattern or generated according to a predetermined algorithm.

6. The method of claim 1, wherein encrypting the firmware image complies with an Advanced Encryption Standard (AES).

7. The method of claim 6, wherein encrypting the firmware image is performed in a Cipher Block Chaining (CBC) mode.

8. The method of claim 1, wherein the firmware image is applicable to an optical disc drive.

9. A method for obtaining a firmware image from an encrypted data having an encrypted firmware image generated according to an encryption key specified for securing a distribution of the firmware image, the method comprising:
providing a decryption key specified for decrypting the encrypted data, wherein the encrypted data further comprises an authentication code for validating the distribution of firmware image;
decrypting the encrypted firmware image utilizing the decryption key to obtain the firmware image.

10. The method of claim 9, wherein before the step of providing a decryption key, the method further comprises a step of utilizing the authentication code to validate the encrypted data.

11. The method of claim 9, wherein the method further comprises a step of utilizing the authentication code to validate decryption of the encrypted firmware image.

12. The method of claim 9, wherein the encrypted data is received via the Internet.

13. The method of claim 9, wherein decrypting the encrypted firmware image complies with an Advanced Encryption Standard.

14. The method of claim 13, wherein decrypting the encrypted firmware image is performed in a Cipher Block Chaining mode.

15. The method of claim 9, wherein the firmware image is applicable to an optical disc drive.

16. An encryption apparatus for securing a distribution of a firmware image, the encryption apparatus comprising:
an encryption key provider capable of generating an encryption key specified for securing the distribution of the firmware image;
an encryption unit, coupled to the encryption key provider, for encrypting the firmware image utilizing the encryption key; and
an authentication code provider, coupled to the encryption unit, for providing an authentication code used for validating distribution of the firmware image.

17. The encryption apparatus of claim 16, wherein the encryption unit further encrypts the authentication code.

18. The encryption apparatus of claim 16, wherein the authentication code provider further adds the authentication code to the encrypted firmware image.

19. The encryption apparatus of claim 16, wherein the firmware image is to be distributed via the Internet.

20. The encryption apparatus of claim 16, wherein the authentication code provider provides a fixed pattern as the authentication code or generates the authentication code according to a predetermined algorithm.

21. The encryption apparatus of claim 16, wherein the encryption unit encrypts the firmware image according to an Advanced Encryption Standard.

22. The encryption apparatus of claim 21, wherein the encryption unit encrypts the firmware image in a Cipher Block Chaining mode.

23. The encryption apparatus of claim 16, wherein the firmware image is applicable to an optical disc drive.

24. A decryption apparatus for obtaining a firmware image from an encrypted data having an encrypted firmware image generated according to an encryption key specified for securing a distribution of the firmware image, the decryption apparatus comprising:
a decryption key provider capable of providing a decryption key specified for decrypting the encrypted data, wherein the encrypted data comprises an authentication code for validating the distribution of the firmware image; and
a decryption unit, coupled to the decryption key provider, for decrypting the encrypted firmware image utilizing the decryption key to obtain the firmware image.

25. The decryption apparatus of claim 24, wherein the decryption apparatus further comprises a validation unit, coupled to the decryption key provider, for utilizing the authentication code to validate the encrypted firmware image.

26. The decryption apparatus of claim 24, wherein the decryption apparatus further comprises a validation unit, coupled to the decryption unit, for utilizing the authentication code to validate decryption of the encrypted firmware image.

27. The decryption apparatus of claim 24, wherein the encrypted data is received via Internet.

28. The decryption apparatus of claim 24, wherein the decryption unit decrypts the encrypted firmware image according to an Advanced Encryption Standard.

29. The decryption apparatus of claim 28, wherein the decryption unit decrypts the encrypted firmware image in a Cipher Block Chaining mode.

30. The decryption apparatus of claim 24, wherein the firmware image is applicable to an optical disc drive.
